(19) United States
(12) Patent Application Publication
(10) Pub. No.: US 2026/0319294 A1
(43) Pub. Date: Oct. 15, 2026

(54) BACKLIGHT MODULE AND PREPARATION METHOD THEREFOR, AND DISPLAY PANEL

(71) Applicant: WUHAN CHINA STAR OPTOELECTRONICS TECHNOLOGY CO., LTD., Wuhan, Hubei (CN)

(72) Inventors: Ze ZHANG, Wuhan, Hubei (CN); Wei ZHOU, Wuhan, Hubei (CN); Lei ZHU, Wuhan, Hubei (CN)

(73) Assignee: WUHAN CHINA STAR OPTOELECTRONICS TECHNOLOGY CO., LTD., Wuhan, Hubei (CN)

(21) Appl. No.: 18/860,614

(22) PCT Filed: Jun. 30, 2023
(86) PCT No.: PCT/CN2023/104728

§ 371 Date: Oct. 25, 2024

(30) Foreign Application Priority Data
Jan. 31, 2023 (CN) 202310099688.2

(51) Int. Cl. F21V 8/00

(52) U.S. Cl. CPC G02B 6/0088

(57) ABSTRACT

Embodiments of the present disclosure provide a backlight module, a preparation method therefor, and a display device. The backlight module comprises: a backplane; a light plate arranged at one side of the backplane; and a backlight film arranged at a side, away from the backplane, of the light plate; wherein orthographic projections of the backlight film and the light plate on the backplane coincide with the backplane.

### TECHNICAL FIELD

The present application relates to the field of display technologies, and in particular, to a backlight module and a preparation method therefor, and a display device.

### BACKGROUND

As a light source, a Mini Light Emitting Diode (MLED) has the advantages of small size, long life, and high efficiency, which can be used continuously for up to 100,000 hours. MLED technology has great potential to become one of the development directions of next-generation display technology.

MLED can be used as a backlight and also as a direct display. As a backlight, MLED is commonly used in a liquid crystal display (LCD). An LCD is constructed by placing a liquid crystal cell between two parallel glass substrates, arranging a thin film transistor (TFT) on a lower substrate glass, and arranging a color filter on an upper substrate glass. The rotation direction of liquid crystal molecules is controlled by signals and voltage changes on the TFT, so as to achieve the purpose of display by controlling the emission of polarized light at each pixel point. Compared to LED modules with traditional backlight, MLED as a backlight adopts a denser chip arrangement to reduce light mixing distance, so as to achieve an ultra-thin light source module.

### SUMMARY

However, in the existing display panel where MLED is used as a backlight source, there are assembly tolerances between a light plate and a backlight film due to the large amount of film materials in the backlight film, which affects visual effect and display effect at edges of a backlight module.

Embodiments of the present disclosure provide a backlight module, a preparation method therefor, and a display panel to reduce assembly tolerances between a light plate and a backlight film, improve visual and display effects at edges of the backlight module, and thereby improve image quality of the display panel.

In a first aspect, an embodiment of the present disclosure provides a backlight module, including:
a backplane;
a light plate arranged at one side of the backplane; and
a backlight film arranged at a side, away from the backplane, of the light plate;
wherein orthographic projections of the backlight film and the light plate on the backplane are coincided with the backplane.

In a second aspect, an embodiment of the present disclosure provides a display panel, including:
a backlight module as described above; and
a display module arranged at one side of the backlight module.

In a third aspect, an embodiment of the present disclosure provides a preparation method for a backlight module, including steps of:
stacking a backplane substrate, a light plate substrate, and a backlight film substrate in sequence to form a laminated substrate; and
cutting a periphery of the laminated substrate along a stacking direction to form a laminated structure including a backplane, a light plate, and a backlight film, wherein orthographic projections of the backlight film and the light plate on the backplane coincide with the backplane.

### BENEFICIAL EFFECTS

In the backlight module, the preparation method therefor, and the display panel provided by the embodiments of the present disclosure, by arranging orthographic projections of the backlight film and the light plate on the backplane to coincide with the backplane, that is, arranging peripheral edges of the light plate and the backlight film to be aligned with each other, assembly tolerances between the light plate and the backlight film can be reduced or eliminated, so that a phenomenon of a bluish edge caused by misalignment between the backlight film and the light plate is mitigated, and visual and display effects at edges of the backlight module are improved, and therefore image quality of the display panel is enhanced. Moreover, edges of the backplane are also aligned with edges of the light plate and the backlight film, so that compared to a bent backplane, the manufacturing process thereof can be accelerated.

### BRIEF DESCRIPTION OF THE DRAWINGS

To more clearly illustrate the technical solutions of the present disclosure, a brief introduction to the drawings used in the description of the embodiments will be provided below. It is evident that the drawings described below represent only some embodiments of the present disclosure, and for those skilled in the art, other drawings can be derived from these drawings without creative labor.

To achieve a more comprehensive understanding of the present disclosure and its beneficial effects, the following description will be provided in conjunction with the accompanying drawings. In the following description, the same reference numerals will be used to denote the same components.

FIG. 1 is a schematic diagram of a structure of a display panel according to an embodiment of the present disclosure.

FIG. 2 is a cross-sectional schematic diagram of the structure of the display panel illustrated in FIG. 1 taken along line A-A.

FIG. 3 is a schematic diagram of a first structure of a backlight module according to an embodiment of the present disclosure.

FIG. 4 is a schematic diagram of a second structure of a backlight module according to an embodiment of the present disclosure.

FIG. 5 is a cross-sectional schematic diagram of a structure of the backlight module illustrated in FIG. 4 taken along line B-B.

FIG. 6 is a schematic flowchart illustrating a preparation method for a backlight module according to an embodiment of the present disclosure.

### DETAILED DESCRIPTION

Technical solutions in the embodiments of the present disclosure will be clearly and completely described with reference to the accompanying drawings. It will be apparent that the described embodiments are only some of the embodiments of the present disclosure, but not all of them. Based on the embodiments in the present disclosure, other embodiments obtained by the skilled person in the art without creative labor all fall within the scope of the present disclosure.

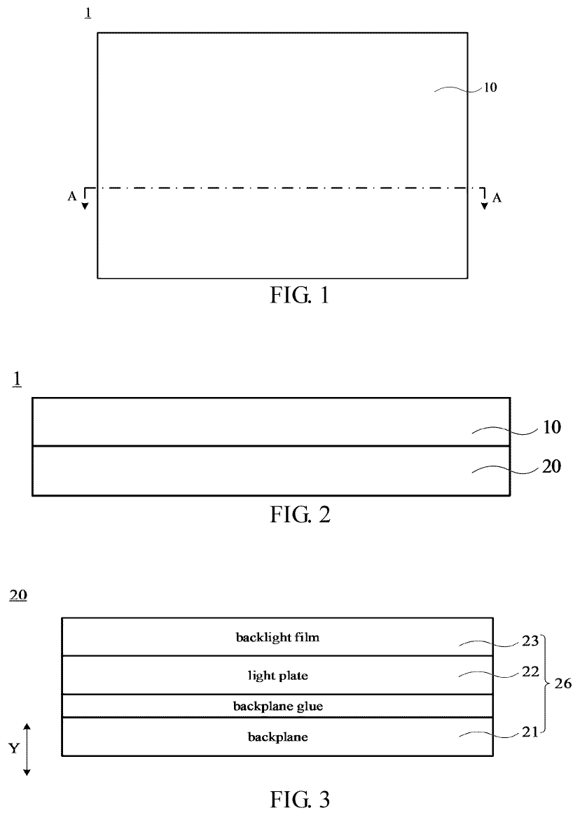

Please refer to FIG. 1 illustrating a schematic diagram of a structure of a display panel according to an embodiment of the present disclosure, and FIG. 2 illustrating a cross-sectional schematic diagram of the structure of the display panel illustrated in FIG. 1 taken along line A-A. The display panel 1 includes a display module 10 and a backlight module 20, which are arranged in a stack. For example, the display panel 1 has a light-emitting side, and the display module 10 is arranged on a side of the backlight module 20 facing the light-emitting side. For example, the display panel 1 is a liquid crystal display panel, that is, an LCD. An LCD is constructed by placing a liquid crystal cell between two parallel glass substrates, and arranging a thin film transistor (TFT) on a lower substrate glass and a color filter on an upper substrate glass. The rotation direction of liquid crystal molecules is controlled by signals and voltage changes on the TFT, thereby achieving a purpose of displaying by controlling emission of polarized light at each pixel point, and realizing imaging of the display panel 1 in combination with light emitted from a backlight source. In other words, the display module 10 includes the aforementioned upper substrate glass with the color filter arranged thereon, the lower substrate glass with the thin film transistor arranged thereon, and the liquid crystal cell arranged between the upper substrate glass and the lower substrate glass. The backlight module 20 is configured to provide a backlight source for the display module 10, and the light source of the backlight module 20 can be a MLED.

MLED technology has great potential to become one of the development directions of next-generation display technology. Introduction of MLED technology in mid-and-high-end tablet computers and notebook computers has significantly enhanced the dark state display performance of LTPS (Low Temperature Poly-silicon)-LCD products. Compared to OLED (Organic Light-Emitting Diode), despite needing further improvement in thickness and response time, MLED exhibits significant advantages regarding power consumption, HDR (High Dynamic Range imaging) standards, CR (Color Rendering), brightness, and product reliability. However, there are assembly tolerances between a light plate and a backlight film due to a large amount of film materials in the backlight film, which affects visual effect and display effects at edges of backlight modules.

In order to improve the aforementioned situation, the embodiments of the present disclosure have improved the structure of the backlight module 20. This will be described below from two aspects: the structural composition of and the preparation method for the backlight module 20.

Please refer to FIG. 3 illustrating a schematic diagram of a first structure of a backlight module according to an embodiment of the present disclosure, in combination with FIG. 1 and FIG. 2. The backlight module 20 includes a backplane 21, a light plate 22, and a backlight film 23. The light plate 22 is arranged on one side of the backplane 21, and the backlight film 23 is arranged on a side, away from the backplane21, of the light plate 22. Herein, orthographic projections of the backlight film 23 and the light plate 22 on the backplane 21 coincide with the backplane 21.

In the backlight module 20 provided by the embodiments of the present disclosure, by arranging orthographic projections of the backlight film 23 and the light plate 22 on the backplane 21 to coincide with the backplane 21, that is, arranging peripheral edges of the light plate 22 and the backlight film 23 to be aligned with each other, assembly tolerances between the light plate 22 and the backlight film 23 can be reduced or eliminated, so that a phenomenon of a bluish edge caused by misalignment between the backlight film 23 and the light plate 22 is mitigated, and visual and display effects at edges of the backlight module 20 are improved, and therefore image quality of the display panel 1 is enhanced. Moreover, edges of the backplane 21 are also aligned with edges of the light plate 22 and the backlight film 23, so that compared to a bent backplane, the manufacturing process thereof can be accelerated.

The backplane 21, serving as a supportive and load-bearing component of the backlight module 20, can be made of a rigid metal material to ensure adequate strength and support. For example, the backplane 21 can be made of a steel plate or an aluminum plate.

The light plate 22, serving as a primary light-emitting component of the backlight module 20, may include a light frame and an array of light-emitting chips arranged thereon. These chips may be MLED chips. The light plate 22 is arranged on the backplane 21. For example, the light plate 22 can be bonded to the backplane 21 by backplane glue.

Performance of the entire backlight module 20 is determined by the backlight film 23, where a brightness-enhancing film having a prismatic microstructure can effectively enhance brightness, uniformity, and contrast ratio of illumination, and can indirectly improve power consumption efficiency of the backlight module. Under a specific light source output, frontal brightness, or so-called axial luminance of a liquid crystal module will be enhanced by utilizing a prism film, a reflective polarizing film, and a high-reflectivity reflector. To enhance axial luminance without increasing number of light sources, two strategies can be implemented: firstly, an angular distribution of light is improved to concentrate the light within frontal viewing angles; and secondly, the loss is reduced to increase total light output. The backlight film 23 can not only mix light to disperse the light evenly, but also convert blue light into white light, etc.

In the prior art, due to misalignments at the edges of the backlight module in reasons of cutting tolerances and assembly tolerances between the light panel and the backlight film, undesirable visual artifacts such as blue edges and dark edges are easily generated.

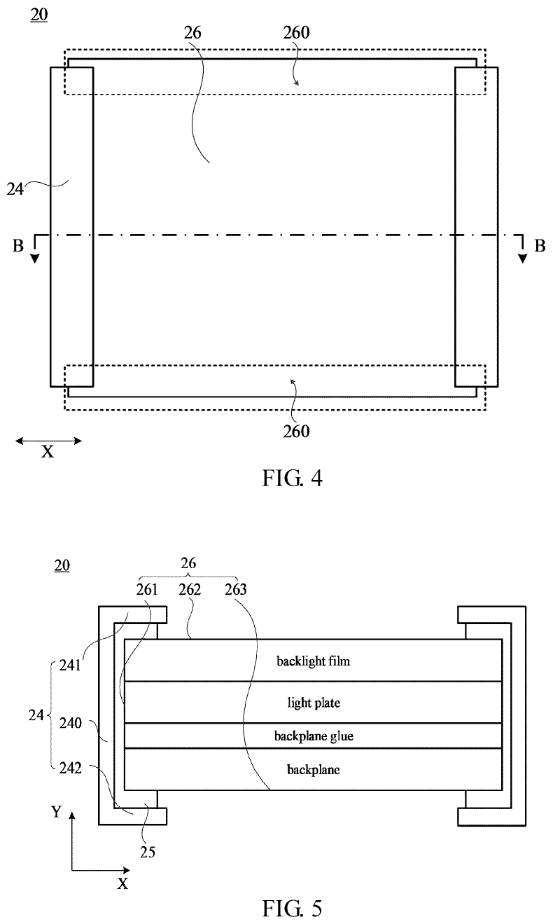

Please refer to FIG. 4 illustrating a schematic diagram of a second structure of a backlight module according to an embodiment of the present disclosure, and FIG. 5 illustrating a cross-sectional schematic structural of a structure of the backlight module illustrated in FIG. 4 taken along line B-B, in combination with FIGS. 1-3. To address the aforementioned problems, the edges of the backlight module 20 are trimmed as a whole according to the embodiments of the present disclosure, so as to reduce a tolerance gap between the backlight film 23 and the light plate 22. For example, a laminated structure 26 is formed by the backplane 21, the light plate 22 and the backlight film 23. That means, the backplane 21, the light plate 22, and the backlight film 23 form a single entity, with the laminated structure 26 including four ends 260 opposite to each other in pairs. It should be understood that the backplane 21, the light plate 22, and the backlight film 23 could each be rectangular or square in shape. Therefore, tacking and overlapping of the backplane 21, the light plate 22, and the backlight film 23 can result in four ends 260 opposite to each other in pairs.

In an embodiment, the backlight module 20 further includes a connecting plate 24, arranged on at least one end 260 of the laminated structure 26, and configured to connect an end of the backplane 21, an end of the light plate 22, and an end of the backlight film 23 on a same side.

For example, the connecting plate 24 might be made of a metal material to enhance the connection strength at ends of the laminated structure 26. Additionally, the connecting plate 24 and the backplane 21 could be made of the same material, such as a steel plate or an aluminum plate. A thickness of the connecting plate 24 can be consistent with that of the backplane 21. And thicknesses within a specified tolerant range, such as 5% can also be considered consistent. In the prior art, the backplane is typically bent to envelop the light plate and the backlight film. An uneven arrangement of the backplane can result in insufficient structural strength for the entire backlight module. In the embodiments of the present disclosure, the connecting plate 24 can be considered as a small connecting member disassembled from the backplane, which can enhance overall strength of the backlight module 20 and improve overall optical quality at the edges.

In an embodiment, the connecting plate 24 can cover part of the laminated structure 26, thereby tightly connecting the backplane 21, the light plate 22, and the backlight film 23 within the laminated structure 26, and enhancing overall strength of the backlight module 20. For example, the connecting plate 24 includes a side plate 240, a top plate 241, and a bottom plate 242. The side plate 240 is attached to a side wall 261 of the laminated structure 26. The top plate 241 is connected to the side plate 240 to form a bend and attached to a top wall 262 of the laminated structure 26. The bottom plate 242 is connected to the side plate 240 to form a bend, arranged to be opposite to the top plate 241, and attached to a bottom wall 263 of the laminated structure 26. It can be understood that the connecting plate 24 may have a U-shaped structure, with an opening of the U-shape clamped on the end 260 of the laminated structure 26.

In an embodiment, a connecting glue 25 is arranged between the connecting plate 24 and the laminated structure 26. The connecting glue 25 can fill the space between the connecting plate 24 and the laminated structure 26, serving as a buffer and a connector, so that a reliable connection between the connecting plate 24 and the laminated structure 26 is ensured, and therefore the stability of the backlight module 20 can be enhanced.

For example, the connecting plate 24 may be arranged at only one end 260 of the four ends 260 of the laminated structure 26. The backplane 21, the light plate 22, and the backlight film 23 are stacked along a stacking direction Y. Within the connecting plate 24, the top plate 241 and the bottom plate 242 extend in a horizontal direction X, which is perpendicular to the stacking direction Y of the laminated structure 26. Lengths of the top plate 241 and the bottom plate 242 in the horizontal direction X are equal. However, equality mentioned herein is not an absolute equality. Due to manufacturing tolerances, lengths of the top plate 241 and the bottom plate 242 having tolerances within a given tolerance range, such as 5%, can be considered equal in length. Of course, lengths of the top plate 241 and the bottom plate 242 may also differ. For instance, if the bottom plate 242 is longer than the top plate 241, the load-bearing stability of the laminated structure 26 can be enhanced.

In an embodiment, the connecting plate 24 is arranged on at least one end 260 of the laminated structure 26. In the horizontal direction X, a ratio of a length of the top plate 241 to a length of the laminated structure 26 is less than or equal to 0.1, and/or a ratio of a length of the bottom plate to a length of the laminated structure is less than or equal to 0.1. For instance, if the length of the laminated structure 26 is 100 cm, the length of the top plate 241 can be 10 cm so as to enhance the overall rigidity of the backlight module 20 without compromising display quality of the light source in the light plate 22.

For example, two connecting plates 24 may be arranged at two ends 260 of the four ends 260 of the laminated structure 26. The two ends 260 could be adjacent or opposite ends 260. Taking the two oppositely arranged ends 260 as an example, the two connecting plates 24 can be symmetrically arranged along the center line extending in the stacking direction Y of the laminated structure 26. That means, two U-shaped panels are arranged oppositely, and their openings are opposite, so that compared to the arrangement with a single connecting plate 24, the stability of the backlight module 20 can be enhanced. Taking the laminated structure 26 with an upper end, a lower end, a left end, and a right end as an example, the connecting plates 24 can be arranged respectively at the upper end and the left end or the right end, or alternatively, the connecting plates 24 can be arranged respectively at the left end and the right end.

For example, three connecting plates 24 may be arranged at three ends 260 of the four ends 260 of the laminated structure 26. Two of the three ends 260 are opposite to each other. One end 260 is adjacent to the two opposite ends 260. Taking the laminated structure 26 with an upper end, a lower end, a left end, and a right end as an example, the connecting plates 24 can be respectively arranged at the upper end, the left end, and the right end, while the lower end is unoccupied to facilitate an arrangement of wirings of the backlight module 20, etc.

To more clearly elucidate the structural composition of the backlight module 20 according to the embodiments of the present disclosure, the following description will proceed in view of the preparation method for the backlight module.

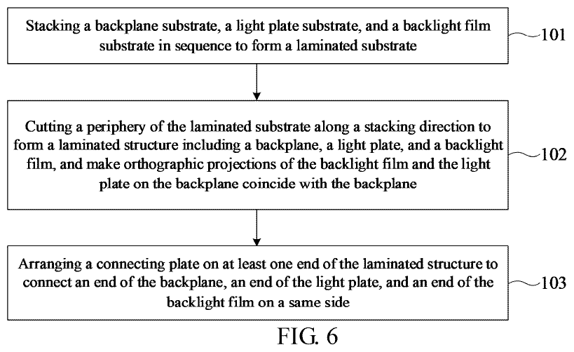

For example, please refer to FIG. 6 illustrating a schematic flowchart illustrating a preparation method for a backlight module according to an embodiment of the present disclosure, in combination with FIGS. 1-5. An embodiment of the present disclosure provides a preparation method for a backlight module, including:

Step 101. Stacking a backplane substrate, a light plate substrate, and a backlight film substrate in sequence to form a laminated substrate.

In a backlight module manufacturing process, the completed backplane substrate, light plate substrate, and backlight film substrate are firstly provided, where a completed manufacture means that only cutting is required on the substrates to form a required size, which in view of the light plate substrate refers to a state where the MLED chips have been arranged on the light frame, and in view of the backlight film substrate refers to a state where multiple films have been stacked and bonded together.

The aforementioned substrates can be stacked in a vertical direction. In the vertical direction, the backplane substrate, the light plate substrate, and the backlight film substrate are stacked in sequence to form a laminated substrate.

Step 102. Cutting a periphery of the laminated substrate along a stacking direction to form a laminated structure including a backplane, a light plate, and a backlight film, and make orthographic projections of the backlight film and the light plate on the backplane coincide with the backplane.

The periphery of the laminated substrate is cut along the stacking direction to form a laminated structure with neat edges. This cut laminated structure includes a backplane, a light plate, and a backlight film, stacked sequentially, where orthographic projections of the backlight film and the light plate on the backplane coincide with the backplane.

It should be noted that in the prior art, it is common to assemble the light plate and the backlight film first, and then install them on the backplane using backplane glue. The periphery of the backplane is bent to envelop the light plate and the backlight film. The backlight module mounted in this manner can easily result in large assembly tolerances between the light plate and the backlight film, thereby affecting edge quality of the backlight module.

To improve the aforementioned situation, the stacked laminated substrate is cut uniformly according to an embodiment of the present disclosure, so that peripheral edges of the light plate and the backlight film are arranged to be aligned with each other, and therefore display effects at edges of the backlight module are improved. Moreover, the backplane is also cut together with the light plate and the backlight film, which can save the manufacturing process thereof and accelerate the preparation for the backlight module.

Step 103. Arranging a connecting plate on at least one end of the laminated structure to connect an end of the backplane, an end of the light plate, and an end of the backlight film on a same side.

The laminated structure may have four opposite ends. To tightly connect the backplane, the light plate, and the backlight film within the laminated structure, a connecting plate may be arranged on at least one end of the laminated structure, thereby connecting the end of the backplane, the end of the light plate, and the end of the backlight film on a same side.

The connecting plate may have a U-shaped structure with an opening of the U-shape clamped on at least one end of the laminated structure. The connecting plate may include a side plate, a top plate, and a bottom plate. The side plate may be arranged vertically. The top plate and the bottom plate are opposite each other, and both extend in parallel directions. The top plate is connected to the side plate to form a bend. Similarly, the bottom plate is connected to the side plate to form a bend. During a preparation process, a plate should be arranged on at least one end of the laminated structure, and two ends of the plate are bent to form a connecting plate consisting of a top plate, a side plate, and a bottom plate connected sequentially. The top plate is attached to a top wall of the laminated structure, the side plate is attached to a side wall of the laminated structure, and the bottom plate is attached to a bottom wall of the laminated structure.

A single connecting plate can be arranged at one end of the laminated structure. It is also possible that two connecting plates are arranged at two ends of the laminated structure, or three connecting plates are arranged at three ends of the laminated structure. When multiple connecting plates are arranged, they can be manufactured uniformly and arranged simultaneously at the respective ends of the laminated structure.

A connecting glue can be applied to fill the space between the connecting plate and the laminated structure, serving both as a buffer and as a connector, thereby enhancing the overall strength and stability of the backlight module.

In the preparation method for the backlight module provided by the embodiments of the present disclosure, by arranging orthographic projections of the backlight film and the light plate on the backplane to coincide with the backplane, that is, arranging peripheral edges of the light plate and the backlight film to be aligned with each other, assembly tolerances between the light plate and the backlight film can be reduced or eliminated, so that a phenomenon of a bluish edge caused by misalignment between the backlight film and the light plate is mitigated, and visual and display effects at edges of the backlight module are improved, and therefore image quality of the display panel is enhanced. Moreover, edges of the backplane are also aligned with edges of the light plate and the backlight film, so that compared to a bent backplane, the manufacturing process thereof can be accelerated. In the embodiments of the present disclosure, the entire backplane is stacked together with the light plate and the backlight film, and then they are trimmed as a whole using a cutting-die, so that the tolerance gap between the backlight film and the light plate can be reduced. Thereafter, the bottom backplane and the upper backlight film are connected via a U-shaped connecting plate and double-sided adhesive, which not only increases overall strength of the backlight module but also enhances overall optical quality at the edges.

In the aforementioned embodiments, the description of each embodiment focuses on different perspectives, and contents not described in detail in a certain embodiment may be referred to the related description in other embodiments.

In the description of the present disclosure, it is to be understood that the terms “first”, “second” and the like are used for descriptive purposes only and are not to be construed as indicating or implying relative importance or implying an amount of indicated technical features. Thus, features defined with “first” and “second” may explicitly or implicitly include one or more of the feature.

The present disclosure has been described in detail with reference to a backlight module and a preparation method therefor, and a display panel provided in the embodiments of the present disclosure. Specific examples are used herein to illustrate the principles and embodiments of the present disclosure. The description of the above embodiments is merely intended to help understand the technical solutions and the core idea of the present disclosure. At the same time, those skilled in the art may make modifications to the specific implementation modes and applying ranges based on concepts disclosed herein. In summary, the content of the description should not be construed as limiting the scope of the present disclosure.

1. A backlight module, comprising:
a backplane;
a light plate arranged at one side of the backplane; and
a backlight film arranged at a side, away from the backplane, of the light plate;
wherein orthographic projections of the backlight film and the light plate on the backplane are coincided with the backplane.

2. The backlight module of claim 1, wherein a laminated structure is formed by the backplane, the light plate, and the backlight film, and the laminated structure includes four ends opposite to each other in pairs;
wherein the backlight module further comprises:
a connecting plate arranged on at least one end of the laminated structure, and configured to connect an end of the backplane, an end of the light plate, and an end of the backlight film on a same side.

3. The backlight module of claim 2, wherein the connecting plate comprises:
a side plate attached to a side wall of the laminated structure;
a top plate connected to the side plate to form a bend, and attached to a top wall of the laminated structure; and
a bottom plate connected to the side plate to form a bend, arranged to be opposite to the top plate, and attached to a bottom wall of the laminated structure.

4. The backlight module of claim 3, wherein the top plate and the bottom plate extend in a horizontal direction perpendicular to a stacking direction of the laminated structure, and lengths of the top plate and the bottom plate in the horizontal direction are equal.

5. The backlight module of claim 3, wherein in a horizontal direction perpendicular to a stacking direction of the laminated structure, a ratio of a length of the top plate to a length of the laminated structure is less than or equal to 0.1.

6. The backlight module of claim 3, wherein in a horizontal direction perpendicular to a stacking direction of the laminated structure, a ratio of a length of the bottom plate to a length of the laminated structure is less than or equal to 0.1.

7. The backlight module of claim 2, wherein a connecting glue is arranged between the connecting plate and the laminated structure.

8. The backlight module of claim 2, wherein the connecting plate is made of a metal material.

9. The backlight module of claim 2, wherein the connecting plates are arranged at two opposite ends of the laminated structure.

10. The backlight module of claim 2, wherein the connecting plates are arranged at two adjacent ends of the laminated structure.

11. A display panel, comprising:
a backlight module comprising:
a backplane;
a light plate arranged at one side of the backplane; and
a backlight film arranged at a side, away from the backplane, of the light plate;
wherein orthographic projections of the backlight film and the light plate on the backplane coincide with the backplane; and
a display module arranged at one side of the backlight module.

12. The display panel of claim 11, wherein a laminated structure is formed by the backplane, the light plate, and the backlight film, and the laminated structure includes four ends opposite to each other in pairs;
wherein the backlight module further comprises:
a connecting plate arranged on at least one end of the laminated structure, and configured to connect an end of the backplane, an end of the light plate, and an end of the backlight film on a same side.

13. The display panel of claim 12, wherein the connecting plate comprises:
a side plate attached to a side wall of the laminated structure;
a top plate connected to the side plate to form a bend and attached to a top wall of the laminated structure; and
a bottom plate connected to the side plate to form a bend, arranged to be opposite the top plate, and attached to a bottom wall of the laminated structure.

14. The display panel of claim 13, wherein the top plate and the bottom plate extend in a horizontal direction perpendicular to a stacking direction of the laminated structure, and lengths of the top plate and the bottom plate in the horizontal direction are equal.

15. The display panel of claim 13, wherein in a horizontal direction perpendicular to a stacking direction of the laminated structure, a ratio of a length of the top plate to a length of the laminated structure is less than or equal to 0.1.

16. The display panel of claim 13, wherein in a horizontal direction perpendicular to a stacking direction of the laminated structure, a ratio of a length of the bottom plate to a length of the laminated structure is less than or equal to 0.1.

17. The display panel of claim 12, wherein a connecting glue is arranged between the connecting plate and the laminated structure.

18. A preparation method for a backlight module, comprising:
stacking a backplane substrate, a light plate substrate, and a backlight film substrate in sequence to form a laminated substrate; and
cutting a periphery of the laminated substrate along a stacking direction to form a laminated structure including a backplane, a light plate, and a backlight film, wherein orthographic projections of the backlight film and the light plate on the backplane coincide with the backplane.

19. The preparation method for the backlight module of claim 18, wherein after cutting the periphery of the laminated substrate along the stacking direction to form a laminated structure including a backplane, a light plate, and a backlight film, wherein orthographic projections of the backlight film and the light plate on the backplane coincide with the backplane, the preparation method for the backlight module further comprises:
arranging a connecting plate on at least one end of the laminated structure to connect an end of the backplane, an end of the light plate, and an end of the backlight film on a same side.

20. The preparation method for the backlight module of claim 19, wherein arranging the connecting plate on at least one end of the laminated structure to connect the end of the backplane, the end of the light plate, and the end of the backlight film on the same side comprises:
arranging a plate on at least one end of the laminated structure; and
bending two ends of the plate to form a connecting plate comprising a top plate, a side plate, and a bottom plate connected in sequence, wherein the top plate is attached to a top wall of the laminated structure, the side plate is attached to a side wall of the laminated structure, and the bottom plate is attached to a bottom wall of the laminated structure.
